(19) United States
(12) Patent Application Publication
(10) Pub. No.: US 2009/0108990 A1
(43) Pub. Date: Apr. 30, 2009

(54) Electronic key system and motorcycle using the same

(75) Inventors: Hirohisa Suzuki, Ora-gu (JP); Yoshiyuki Fukuda, Hanyu-shi (JP); Takashi Kunimi, Tokyo (JP)

Correspondence Address: OLIFF & BERRIDGE, PLC, P.O. BOX 320850, ALEXANDRIA, VA, 22320-4850, US

(73) Assignees: Sanyo Electric Co., Ltd., Moriguchi City (JP); Akebono Brake Industry Co., Ltd., Tokyo (JP)

(21) Appl. No.: 11/921,004

(22) PCT Filed: Apr. 17, 2006
(86) PCT No.: PCT/JP2006/308029

§ 371 Date: Nov. 26, 2007

(30) Foreign Application Priority Data
May 31, 2005 (JP) 2005-160243

(51) Int. Cl. B60R 25/00; G05B 19/00; B62D 61/00

(52) U.S. Cl. 340/5.73; 340/5.7; 180/218

(57) ABSTRACT

The present invention provides a battery-free electronic key used in motorcycles and improves security.

A communication circuit (44) is actuated when an electronic key is inserted into a keyhole. An electromotive force generated in a coil L2 is rectified by a power circuit (74) and supplied to the components of an electronic key-side circuit (40) as a source of power, in accordance with the variations of an electromagnetic field having a frequency of f0 generated by the communication circuit (44). The electronic key-side circuit (40) reads identification information from a storage unit (72), and the information is converted to ternary value data in a binary value/ternary value conversion circuit (70). Transistors Tr1 and Tr2 are switched on and off in accordance with the bit values of 2-bit data that expresses ternary value data, which generates three-stage variations in the electromagnetic field between coils L1 and L2. The communication circuit (44) detects this fluctuation, and the ternary value/binary value conversion circuit (54) converts the data from a ternary value to binary value data to acquire the original identification information. An ECU (56) verifies the identification information and starts the engine (62) when verification has been established.

### TECHNICAL FIELD

The present invention relates to an electronic key system for controlling functions of a motorcycle such as start and stop of the engine, and to a motorcycle that uses the same.

### BACKGROUND ART

In recent years, keyless entry systems that use RFID (Radio Frequency Identification) technology have become widely used in automobiles. Such keyless entry systems are used to lock and unlock doors by remote control, and the engine may be started without inserting the key in the keyhole. With such a system, identiification information is transmitted and received via wireless communication between the vehicle and the electronic key (electronic-type key). Since wireless communication is possible at relatively large distances, the communication data can be intercepted and recorded, and it is possible that the car may be stolen using the data. In view of this situation, the communication data must be varied at each transmission or another contrivance must be carried out by encoding the identification information using a random code. With remote control, wireless communication from the electronic key to the vehicle often does not occur in a smooth manner. In this case, bidirectional communication is made possible using, e.g., two frequencies between the electronic key and the vehicle in order to confirm whether the instructed operation has been performed, and a contrivance is adopted in which an operation instruction is sent from the electronic key to the vehicle and an operation execution notification is sent from the vehicle to the electronic key.

### DISCLOSURE OF THE INVENTION

### Problems to be Solved by the Invention

Encoding and bidirectional communication such as those described above are adopted in conventional systems due to the nature of remote control, and there is therefore a problem in the sense that the circuit configuration is complex. Electronic keys in particular require a communication distance, and to the extent that processing is complicated, power consumption is also relatively high. For this reason, there is a drawback in that it is difficult to configure a passive system that does not have a battery.

In the case of a motorcycle, for example, doors are not opened and closed, and there is little need to use remote control. In other words, an electronic key configuration used for a vehicle can be adopted in a motorcycle, and antitheft is improved when an electronic key is used in comparison with a conventional mechanical key.

The present invention was contrived in order to solve the above-described problems, and an object thereof is to provide a configuration that can make the electronic key a passive key that does not require a battery, and in which the security is high and the circuit configuration is simplified in an electronic key system that uses an electronic key mounted on an apparatus that performs verification.

### Means for Solving the Problems

The electronic key system of the first aspect of the present invention is a system having an electronic key for holding identification information and a verification unit for wirelessly connecting to the mounted electronic key and verifying the electronic key, wherein the verification unit has a mounting unit that allows the electronic key to be mounted and dismounted, a communication circuit that is disposed adjacent to the mounting unit, generates a temporally varying transmission electromagnetic field, and detects electromagnetic field variations originating in the electronic key, and a controller for acquiring the identification information on the basis of the detected electromagnetic field variations, performing verification on the basis of the identification information, and controlling prescribed operation control in accordance with the results of the verification; and wherein the electronic key has an antenna for converting the variations in the transmission electromagnetic field to drive power of the electronic key and generating the electromagnetic field variations, a storage unit for holding the identification information, and a response circuit for varying in a plurality of stages electric current that flows to the antenna in accordance with data that expresses the identification information, and generating the electromagnetic field variations.

In the electronic key system of the second aspect of the present invention, the response circuit varies the electric current that flows to the antenna in accordance with n-value data (wherein n is an integer of 3 or higher) that expresses the identification information.

The electronic key system of the third aspect of the present invention is the system of above-described second aspect, wherein the response circuit switches the impedance of the antenna in n stages.

The electronic key system of the fourth aspect of the present invention is the system of the above-described third aspect, wherein the n-value data is expressed in m bits (wherein m is a natural number that meets the expression 2^{m-1}<n≦2^{m}) of binary data; the response circuit has a selection circuit for outputting in parallel m number of selection signals corresponding to the bit values of the n-value data, and m number of resistor circuits provided in accordance with the selection signals and mutually connected in parallel to the antenna; and the resistor circuits have mutually differing resistance values, and also have switch elements for interrupting the resistor circuits in accordance with the corresponding selection signal.

The electronic key system of the fifth aspect of the present invention is the system of the above-described second to fourth aspects, having a data conversion circuit for converting the identification information stored in the storage unit into n-value data.

The electronic key system of the sixth aspect of the present invention is the system of the above-described second to fourth aspects, wherein the storage unit holds the identification information expressed as n-value data.

The electronic key system of the seventh aspect of the present invention is the system of the above-described first aspect, wherein the electronic key has an stick-shaped insertion portion that houses the antenna, the mounting portion forms a keyhole slot in which the insertion portion can be inserted, and the communication circuit has a communication circuit-side antenna that is disposed along the side surface of the keyhole slot, and which electromagnetically couples with the antenna of the electronic key.

The electronic key system of the eighth aspect of the present invention is the system of the above-described seventh aspect, wherein the insertion portion has a recess formed in the surface facing the side surface of the keyhole slot, and the mounting portion has a latch that receives an urging force, retractably protrudes from the side surface of the keyhole slot, engages the recess of the inserted insertion portion, and interlocks with the electronic key.

The electronic key system of the ninth aspect of the present invention is the system of the above-described eighth aspect, wherein the keyhole slot is configured to be capable of rotating about the insertion direction of the insertion portion, and the latch releases the interlocking of the electronic key in accordance with the rotation of the keyhole slot.

The electronic key system of the tenth aspect of the present invention is the system of the first aspect and comprises a main switch of a motorcycle, wherein the verification unit has a verification operation switch that operates in coordination with the engine start switch and sets the communication circuit and the controller in an “on” state, and the controller determines whether to allow the engine to start as the operation control.

The electronic key system of the eleventh aspect of the present invention is the system of the eighth or ninth aspect and comprises a main switch of a motorcycle, wherein the mounting portion has a verification operation switch that sets the communication circuit and the controller in an “on” state in accordance with displacement of the latch in a state in which the insertion portion is inserted into the keyhole slot, and the controller determines whether to allow the engine to start when the engine start switch is operated as the operation control.

The motorcycle of a first aspect of the present invention comprises a main switch constituted using the electronic key system of the first aspect described above, wherein a meter unit is provided that is constituted using a display apparatus and that displays a meter in any of a plurality of display formats provided in advance, the electronic key has a selection button, the storage unit stores in advance a plurality of specified information that specifies the display format, the response unit generates the electromagnetic field variations in accordance with the specified information selected when the user operates the selection button, and the controller acquires the specified information on the basis of the electromagnetic field variations detected by the communication circuit, and sets the display format of the meter unit on the basis of the specified information as the operation control.

The motorcycle of a second aspect of the present invention comprises a main switch constituted using the electronic key system of the first aspect described above, wherein a meter unit is provided that is constituted using a display apparatus and that displays a meter in any of a plurality of display formats provided in advance, the electronic key has an input key, the storage unit holds specified information that the user inputs by operating the input key, the response unit generates the electromagnetic field variations in accordance with the specified information, and the controller acquires the specified information on the basis of the electromagnetic field variations detected by the communication circuit, and sets the display format of the meter unit on the basis of the specified information as the operation control.

The motorcycle of a third aspect of the present invention comprises a main switch constituted using the electronic key system of the first aspect described above, wherein a meter unit is provided that is constituted using a display apparatus and that displays a meter in any of a plurality of display formats provided in advance, the electronic key has a receiver that detects input data from a transmission electromagnetic field from an external apparatus, the storage unit holds specified information provided as the input data, the response unit generates the electromagnetic field variations in accordance with the specified information, and the controller acquires the specified information on the basis of the electromagnetic field variations detected by the communication circuit, and sets the display format of the meter unit on the basis of the specified information as the operation control.

The motorcycle of a fourth aspect of the present invention comprises a main switch constituted using the electronic key system of the first aspect described above, wherein a display unit is provided, the electronic key has a selection button, the storage unit stores in advance a plurality of display data of the display unit, the response unit generates the electromagnetic field variations in accordance with the display data selected when the user operates the selection button, and the controller acquires the display data on the basis of the electromagnetic field variations detected by the communication circuit, and sets the display content of the display unit to correspond to the display data as the operation control.

The motorcycle of a fifth aspect of the present invention is comprises a main switch constituted using the electronic key system of the first aspect described above, wherein a display unit is provided, the electronic key has a receiver that detects input data from a transmission electromagnetic field from an external apparatus, the storage unit holds display data of the display unit provided as the input data, the response unit generates the electromagnetic field variations in accordance with display data, and the controller acquires the display data on the basis of the electromagnetic field variations detected by the communication circuit, and sets the display content of the display unit to correspond to the display data as the operation control.

### EFFECT OF THE INVENTION

In accordance with the present invention, an electronic key is mounted in a verification unit, and the communication distance is reduced. Therefore, a passive configuration is used for driving the electronic key using the electromagnetic field energy from the verification unit, and the battery can be dispensed with. The electronic key is mounted in the verification unit, and operation verification via bidirectional communication is therefore not required. Since the communication distance is short, communication power can be reduced and intercepting the communication content from a remote location can be made difficult. Since the communication distance is fixed, good communication quality can be obtained using signal levels having three or more values, whereby security can be improved without depending on complicated encoding routines.

### BRIEF DESCRIPTION OF THE DRAWINGS

FIG. 1 is a schematic side view showing the overall mechanical structure of the main switch portion;

FIG. 2 is a schematic front view showing the overall mechanical structure of the main switch portion;

FIG. 3 is a schematic circuit diagram of the electronic key system of the motorcycle according to the embodiments;

FIG. 4 is a schematic view showing an example of display formats of the display meter; and

FIG. 5 is a schematic view of a motorcycle provided with a display device.

### BEST MODE FOR CARRYING OUT THE INVENTION

The modes (hereinafter referred to as embodiments) for carrying out the present invention are described below with reference to the diagrams.

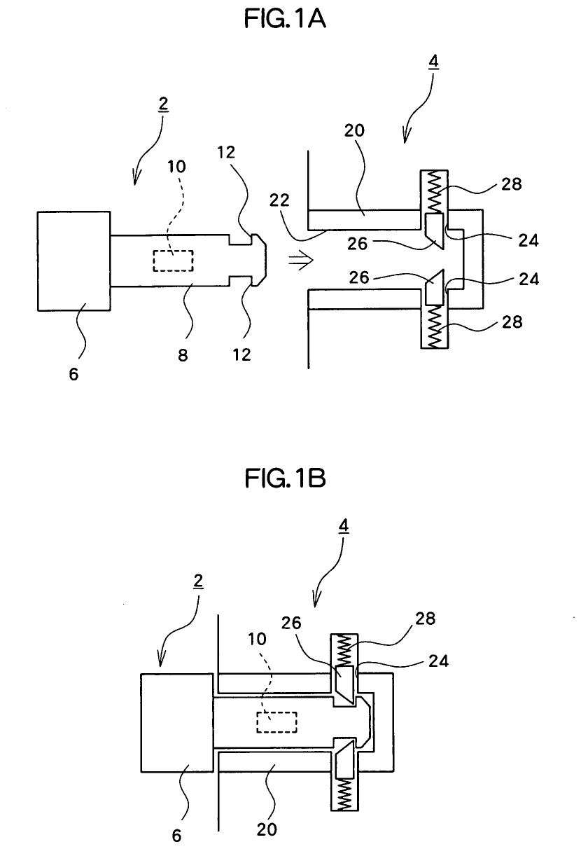

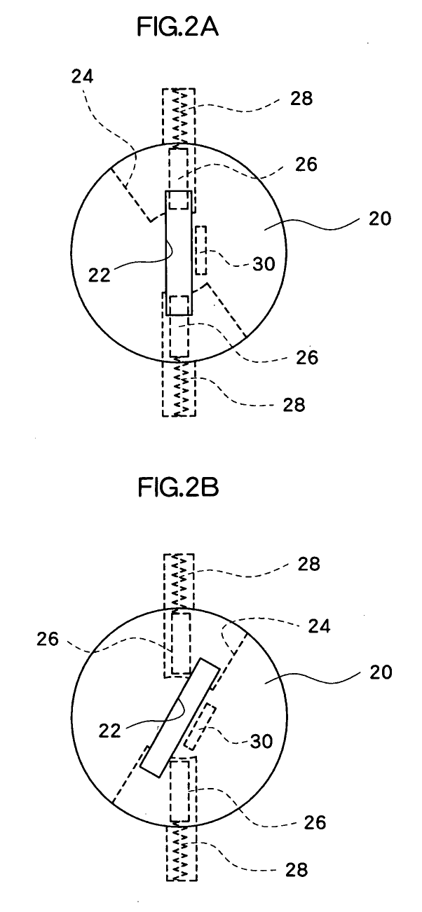

The present embodiment is a motorcycle, and particularly relates to a main switch portion the enables the engine to start. FIGS. 1 and 2 are schematic views showing the overall mechanical structure of the main switch portion. FIG. 1 shows the structure as viewed from the side of an electronic key 2 and a keyhole 4. FIG. 1(a) shows the separated state of the electronic key 2 and the keyhole 4 constituting a portion of the verification unit for verifying that the electronic key are separated, and FIG. 1(b) shows a state in which the electronic key 2 has been inserted into the keyhole. FIG. 2 shows the structure as seen from the front of the keyhole 4. FIG. 2(a) shows a reference position, and FIG. 2(b) shows a situation in which an inserted electronic key 2 has been urged in the right-rotating direction to a position in which the keyhole 4 has been rotated 30°, for example.

The electronic key 2 has a head portion 6 that the user grasps, and an insertion portion 8 that is inserted into the keyhole. The insertion portion 8 houses an electronic circuit substrate 10 on which an antenna, a storage unit, a response circuit, and other components are integrated, and is molded into a stick shape using resin, for example. The distal end of the insertion portion 8 is tapered to a cusp shape, and is formed so that a latch inside the later-described keyhole 4 readily moves away when the insertion portion is inserted into the keyhole 4. Also, a notch 12 engages the latch during insertion and prevents the electronic key 2 from inadvertently falling out of the keyhole 4.

The keyhole 4 is a mounted unit from which the electronic key 2 can be removed, and includes a cylinder 20 that is rotatably embedded in the vehicle body. A keyhole 22 that is shaped so as to be capable of accommodating the insertion portion 8 is provided to the cylinder 20. The cylinder 20 is urged in the left-rotating direction and is latched in the position shown in FIG. 2(a). Two openings 24 are provided in the side surface of the cylinder 20 in mutually opposing positions. These openings 24 are provided in a prescribed range of directions as viewed from the central axis of the keyhole 22. The range of these directions extends to, e.g., 30° in the left-rotating direction from the direction of the major axis of the shape of the keyhole 22 shown in FIG. 2.

A latch 26 is inserted into the openings 24 from outside of the cylinder 20 toward the central axis of the cylinder 20 to a prescribed depth. The depth is set so that the distal end of the latch 26 protrudes inward into the keyhole 22 in the reference position shown in FIG. 1 or 2(a). The latch 26 is retractably configured in the radial direction of the cylinder 20, and a spring 28, for example, is disposed in the rear end side as a means for urging the latch 26 in the central axial direction of the cylinder 20.

A user inserts the electronic key 2 into the keyhole 22 when the motorcycle engine is started (FIG. 1(a)). At this time, the keyhole 22 is in the reference position shown in FIG. 2 (a), and the distal end of the latch 26 protrudes into the keyhole 22 as shown in FIG. 1(a). First, as the electronic key 2 is inserted into the keyhole 22, the distal end of the insertion portion 8 pushes the latch 26 backward, and the notch 12 subsequently arrives at a position that faces the latch 26, whereupon the latch 26 advances and enters into the notch 12, as shown in FIG. 1(b). The latch 26 and notch 12 thereby engage, the insertion portion 8 is prevented from retracting, and the electronic key 2 is prevented from inadvertently falling out. The engagement of the latch 26 is effective for fixedly holding the relative position between the insertion portion 8 and the cylinder 20. As a result, it is possible to achieve smooth electromagnetic coupling between the communication circuit disposed on the cylinder 20 side and the response unit disposed in the electronic circuit substrate 10, as well as the resulting wireless communication. For example, an electronic circuit substrate 30 is housed in the cylinder 20, and the communication circuit described above is mounted on the electronic circuit substrate.

Conversely, when the electronic key 2 is withdrawn, the user grasps the head portion 6 of the electronic key 2 and turns the key in the right-rotating direction against the left-rotating urging force of the cylinder 20. At this time, the cylinder 20 rotates together with the electronic key 2 in the right-rotating direction to reach the state shown in FIG. 2(b). In this case, the above-described directional range of the openings 24 is set so that the latch 26 and the cylinder 20 do not interfere. When the electronic key 2 rotates in the right-rotating direction, the direction of the latch 26 and the direction of the major axis of the keyhole 22 become offset, and the interlocking of the insertion portion 8 with the distal end of the latch 26 is released, as shown in FIG. 2 (b). The user can withdraw the electronic key 2 from the keyhole 22 in this state.

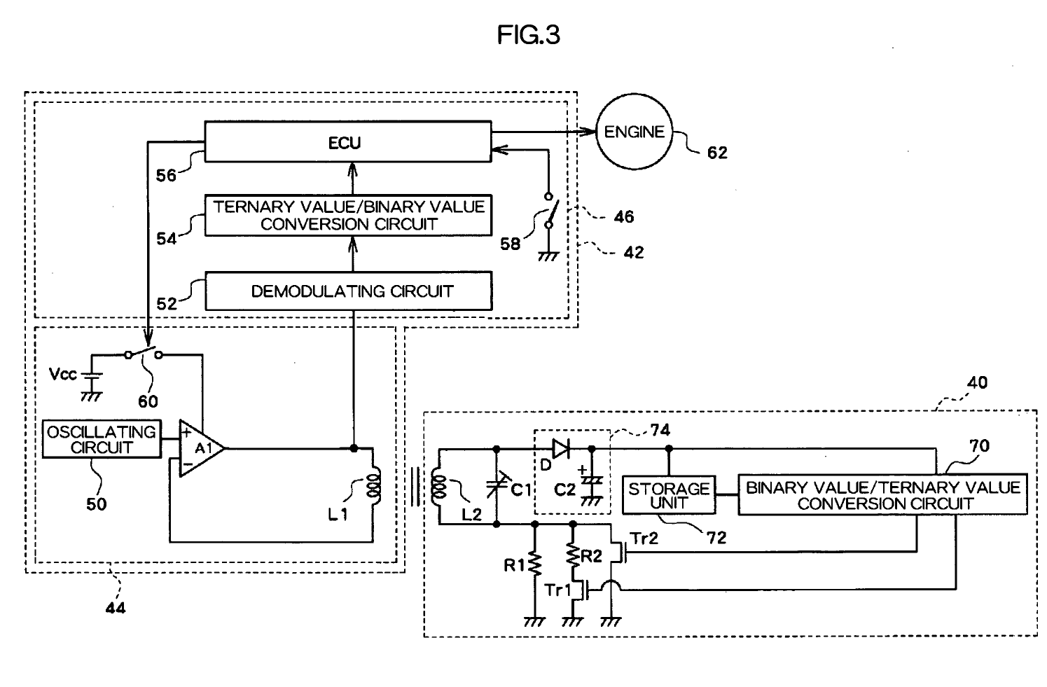

FIG. 3 is a schematic circuit diagram of the electronic key system of a motorcycle. The present system is composed of an electronic key-side circuit 40 formed on the electronic circuit substrate 10 of the electronic key 2, and a vehicle-side circuit 42 provided to the vehicle. The vehicle-side circuit 42 is disposed adjacent to the keyhole 22, generates a transmission electromagnetic field that varies in a temporal manner, and is composed of a communication circuit 44 that detects the electromagnetic field variations produced by the electronic key-side circuit 40, and a controller 46 that acquires the ID (identification information) for identifying the electronic key 2 on the basis of the electromagnetic field variations detected by the communication circuit 44, verifies, based on the ID, whether the electronic key 2 inserted into the keyhole 22 is the electronic key that corresponds to the vehicle, and enables the engine to start based on the verification results. The communication circuit 44 is mounted, for example, on the electronic circuit substrate 30 disposed toward the cylinder 20.

The communication circuit 44 is composed of a coil L1 and an operational amplifier A1. The output terminal and one of the input terminals of the operational amplifier A1 are connected via the coil L1, and an alternating current having a frequency of f0 is generated in the coil L1 in accordance with a clock having a frequency of f0 fed from an oscillating circuit 50 to the other input terminal. The coil L1 detects the electromagnetic field variations generated by the electronic key-side circuit 40 and converts the variations to voltage. Specifically, the voltage changes having a frequency of f0 fed from the operational amplifier A1 to the coil L1 are amplitude modulated in accordance with transmission data from the electronic key-side circuit 40. For example, the voltage of the output terminal of the operational amplifier A1 is brought out as the output voltage of the coil L1.

The voltage thus brought out is inputted to a demodulation circuit 52. The demodulation circuit 52 detects the voltage changes of the output terminal of the operational amplifier A1, extracts transmission data form the electronic key-side circuit 40, and passes the data to a ternary value/binary value conversion circuit 54.

The electronic key-side circuit 40 generates electromagnetic field variations on the basis of ternary data, as described below. In other words, the three stages of intensity changes appear in the transmission electromagnetic field, and the demodulation circuit 52 detects the intensity changes and extracts the ID expressed by the ternary value data from the electronic key-side circuit 40. The ternary value/binary value conversion circuit 54 coverts the ID of the ternary value data from the demodulation circuit 52 into binary value data, i.e., ID binary data, and outputs the result to an ECU (Engine Control Unit) 56.

The ECU 56 determines whether the ID obtained from the ternary value/binary value conversion circuit 54 matches that assigned to the vehicle, and verifies that the electronic key 2 mounted in the keyhole 22 is the proper key when a match is determined. On the other hand, verification of the electronic key 2 fails when a match is not determined.

The verification operation described above is initiated when the user inserts the electronic key 2 in the keyhole 22 and an engine start switch 58 is switched on. The ECU 56 detects that the engine start switch 58 has been switched on and sets the switch 60 in an “on” state. Voltage Vcc is thereby supplied, the communication circuit 44 is actuated, the coil L1 generates a transmission electromagnetic field, and the electronic key-side circuit 40 responds to the transmission electromagnetic field, whereby the verification operation described above is carried out. The ECU 56 starts the engine 62 when verification has been established.

The configuration of the vehicle-side circuit 42 was briefly described above, and the configuration of the electronic key side circuit 40 will be described next. The electronic key-side circuit 40 has a coil L2 as an antenna and is wirelessly connected to the vehicle-side circuit 42 via an electromagnetic field between the coil L2 and the coil L1. For example, the coil L2 is formed as a coil in which the opening surface faces the wide side surface of the stick-shaped insertion portion 8. Conversely, the coil L1 is formed as a coil in which the opening faces the keyhole 22 in the electronic circuit substrate 30 disposed in the side surface of the keyhole 22. When the electronic key 2 is inserted into the keyhole 22, the coil L1 and coil L2 come into close proximity and are transformer-coupled. The present system produces a wireless connection using this configuration, and the coil L1 generates electromagnetic field variations having a frequency of f0 in the communication circuit 44, whereupon an AC voltage having a frequency of f0 is generated at the two ends of the transformer-coupled coil L2.

A capacitor C1 is connected in parallel to the coil L2, and these components constitute a parallel LC resonance circuit. The capacitance of the capacitor C1 is set so that the resonance frequency of the parallel LC resonance circuit is f0. The configuration of this LC resonance circuit allows the coil L2 to produce a resonance phenomenon for those components of the external AC electromagnetic field that have the frequency f0 generated by the communication circuit 44, and to amplify the AC voltage amplitude generated at the two ends of the coil L2.

A first ground circuit composed of a resistor R1, a second ground circuit composed of a series-connected resistor R2 and transistor Tr1, and a third ground circuit composed of a transistor Tr2 are connected in parallel relative to each other to one terminal of the coil L2. These are controlled by the output of the binary value/ternary value conversion circuit 70, which switches the transistors Tr1 and Tr2 on and off.

A storage unit 72 is composed of a flash memory, a one-time memory, or another semiconductor memory, and the ID described above is stored in advance. In this configuration, a binary value/ternary value conversion circuit 70 reads the ID stored in the storage unit 72 in a binary format and converts the data to ternary value data. The ternary value data is, e.g., “0,” “1,” and “2,” and these values are expressed as binary data, i.e., “00,” “01,” and “10,” respectively, in the electronic key-side circuit 40. The binary value/ternary value conversion circuit 70 switches the transistor Tr2 on and off on the basis of, for example, the value of the higher-order bit of the two bits that express the ternary value data, and switches the transistor Tr1 on and off on the basis of value of the lower-order bit. For example, when the ternary value data is “0,” the transistors Tr1 and Tr2 are both switched off; when the ternary value data is “1,” only the transistor Tr1 is switched on; and when the ternary value data is “2,” only the transistor Tr2 is switched on.

Thus, the impedance of the coil L2 is varied in three stages by controlling the transistors Tr1 and Tr2 on the basis of the ternary value data. Specifically, the impedance is reduced in sequence when the two transistors Tr1 and Tr2 are off (when the ternary value data is “0”), when only the transistor Tr1 is on (when the ternary value data is “1”), and when only the transistor Tr2 is on (when the ternary value data is “2”). The change in the impedance of the coil L2 causes variations in the electromagnetic field that couples the coils L1 and L2 together, and affects the voltage between the terminals of the coil L1 in the vehicle-side circuit 42. As described above, the vehicle-side circuit 42 detects the voltage changes using the demodulation circuit 52, and acquires and detects the ID of an inserted electronic key 2.

A power circuit 74 is connected to the other terminal of the coil L2. The power circuit 74 is composed of a diode D and a capacitor C2, and supplies power required by the components of the electronic key-side circuit 40. The diode D is disposed between the input and output terminals of the power circuit 74, and one of the terminals of the capacitor C2 is connected to the output terminal. The other terminal of the capacitor C2 is grounded. The input terminal of the power circuit 74 is connected to the coil L2. The diode D rectifies the alternating current from the coil L2, and the capacitor C2 is charged by the output of the coil. The capacitor C2 is composed of a capacitor having, e.g., an electrolytic capacitor or another large capacitance, and the output of the diode D is smoothed, converted to direct current, and outputted from the power circuit 74. For example, when supplied with power from the power circuit 74, the binary value/ternary value conversion circuit 70 reads the ID from the storage unit 72 and converts the ID to a ternary value data string to sequentially start the above-described operation that controls the transistors Tr1 and Tr2 in a chronological manner.

Described next are the conversion from binary value data to ternary value data in the binary value/ternary value conversion circuit 70, and the conversion from ternary value data to the binary value data in the ternary value/binary value conversion circuit 54. As used herein, n-value data refers to data expressed in a series of n types of symbols. For example, binary value data is data composed of a series of 0's and 1's, i.e., general binary data. On the other hand, ternary value data is data composed of, e.g., 0's, 1's, and 2's. In this case, the ternary value signals are transmitted and received in the electromagnetic field variations between the electronic key-side circuit 40 and the communication circuit 44. To simplify the circuit configuration inside the electronic key-side circuit 40 and the vehicle-side circuit 42, the symbols of the ternary value data are expressed using 2-bit binary data. In other words, the values of the symbols “0,” “1,” and “2” of the ternary value data are expressed as “00,” “01,” and “10” as represented in a binary system as described above.

For example, the binary value/ternary value conversion circuit 70 treats the binary data ID stored in the storage unit 72 as binary numerical data and converts the data to ternary numerical data. At this point, the orders of magnitude of the ternary numbers after conversion are expressed as the 2-bit binary data described above, i.e., “00,” “01,” and “10.” The binary value/ternary value conversion circuit 70 reads, in parallel as two transistor control signals, 2-bit binary data that corresponds to single order ternary data when the transistors Tr1 and Tr2 are controlled.

On the other hand, the ternary value/binary value conversion circuit 54 in the vehicle-side circuit 42 performs the reverse operation of that of the binary value/ternary value conversion circuit 70. First, the demodulation circuit 52 in the vehicle-side circuit 42 converts a single detected ternary value data to 2-bit binary data and outputs the data in a serial fashion. The ternary value/binary value conversion circuit 54 parses the series of 0's and 1's outputted from the demodulation circuit 52 into 2-bit groups that correspond to the ternary value data, coverts the data from a ternary number to a binary number, and reproduces the original ID data.

In the configuration described above, the ID is stored in the storage unit 72 as binary value data. However, data that has been converted to ternary value data, i.e., a series of 2-bit binary data that represents a single order of magnitude of ternary data, may also be stored in the storage unit 72. In such a case, the binary value/ternary value conversion is not required, and in place of the binary value/ternary value conversion circuit 70, a circuit is provided for reading data in 2-bit groups from the storage unit 72 and outputting the data in parallel as the control signals of the two transistors Tr1 and Tr2.

With the present system, ternary value data is exchanged between the electronic key-side circuit 40 and the communication circuit 44. This is based on the fact that errors are not very liable to occur in determining the three intensity levels of the electromagnetic field because it is possible to keep constant the communication between the electronic key-side circuit 40 and the communication circuit 44 carried out when the electronic key 2 has been inserted into the keyhole 22 and the distance between the two. Also, the electronic key-side circuit 40 and the communication circuit 44 are kept in close proximity, whereby the communication circuit 44 can detect even weak electromagnetic field variations generated by the electronic key-side circuit 40.

On the other hand, it is difficult to remotely intercept the electromagnetic field variations between the electronic key-side circuit 40 and communication circuit 44 from the exterior of the present system and to acquire the ID thus exchange. The interception is inhibited because of variations in the distance between intercept point and the coils L1 and L2, and because of variations in the level of the electromagnetic field caused by noise in the intervening distance or caused by considerable distances that weaken the electromagnetic field variations. The electromagnetic field variations are furthermore not limited to three levels specified by ternary value data, and the ID can be exchanged between the electronic key-side circuit 40 and the communication circuit 44 as n number of levels specified by n-value data (n>3) having a greater number of values. Interception is made difficult because it is not evident to the interceptor whether transmission and reception via such electromagnetic field variations are based on a ternary value or a greater number of values. In view of these points, with the present system, there is little need to use complicated encoding routines that use a random number or the like when the ID is exchanged, and such encoding is dispensed with. The circuit configuration of the electronic key-side circuit 40 and the vehicle-side circuit 42 can thereby be simplified. In particular, the circuit configuration or processing of the electronic key-side circuit 40 is simplified, whereby power consumption is reduced and the configuration of the battery-free electronic key-side circuit 40 is made advantageous.

In the configuration described above, the user inserts the electronic key 2 into the keyhole 22 and switches on the engine start switch 58 to supply power to the communication circuit 44, but other configurations are also possible. For example, a configuration is also possible in which power supply to the communication circuit 44 is started as the latch 26 is pushed backward when the electronic key 2 is inserted into the keyhole 22, and the verification operation is performed prior to the operation of the engine start switch 58.

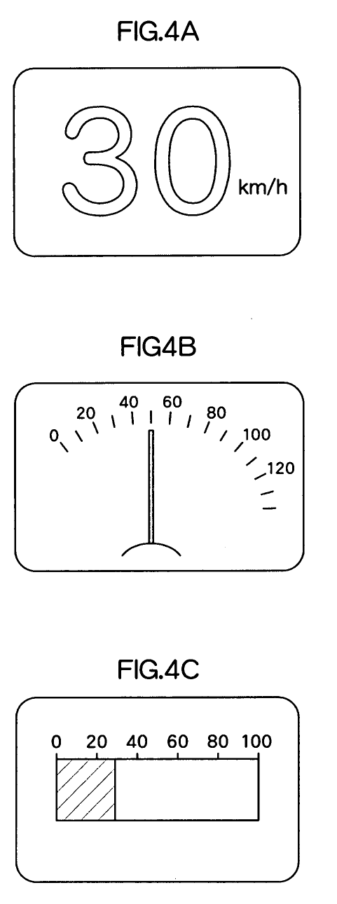

The electronic key 2 may be configured so that data other than the ID that determines whether to allow the engine to start is stored in the storage unit 72, the data is sent to the vehicle in the same manner as the ID described above, and the data is used on the vehicle side. For example, the display meter that displays the speed or other information of the motorcycle may be composed of a liquid crystal display, and the display format may be modifiable in accordance with information that specifies the display format stored in the storage unit 72 of the electronic key 2. FIG. 4 is a schematic view showing an example of display formats of the display meter. FIG. 4(a) shows an example that digitally displays speed using numbers, FIG. 4(b) shows an example of a needle-type meter display, and FIG. 4(c) shows an example of a bar graph display.

It is possible to adopt a configuration in which a plurality of selection buttons is provided to, e.g., the head portion 6 for the electronic key 2 in order to select these displays. The configuration may be one in which the user presses any of the selection buttons, whereby corresponding information that specifies the display format is read from the storage unit 72 and transmitted to the vehicle-side circuit 42.

The configuration may be one in which a numeric keypad or another input key is provided to the head portion 6, and the user can input information that specifies the display format using the input key. In this case, a numerical value or other data inputted by the user is stored in the storage unit 72 as information that specifies the display format, and the information that specifies the display format is read from the storage unit 72 and transmitted to the vehicle-side circuit 42 during communication between the electronic key-side circuit 40 and the communication circuit 44.

The information that specifies the display format may be written to the storage unit 72 using a method other than input keys. For example, a circuit configuration such as the communication circuit 44 and the demodulation circuit 52 may be provided to the electronic key-side circuit 40 of the electronic key 2, and data from external electromagnetic field variations received by the coil L2 may be detected. A configuration may be used in which the information that specifies the display format is transmitted via electromagnetic field variations from an external apparatus to the electronic key 2 in the same manner as writing to a radio frequency identification tag using a reader/writer, the data received by the electronic key 2 is stored in the storage unit 72, and the display format of the meter is specified using the display formation specification information.

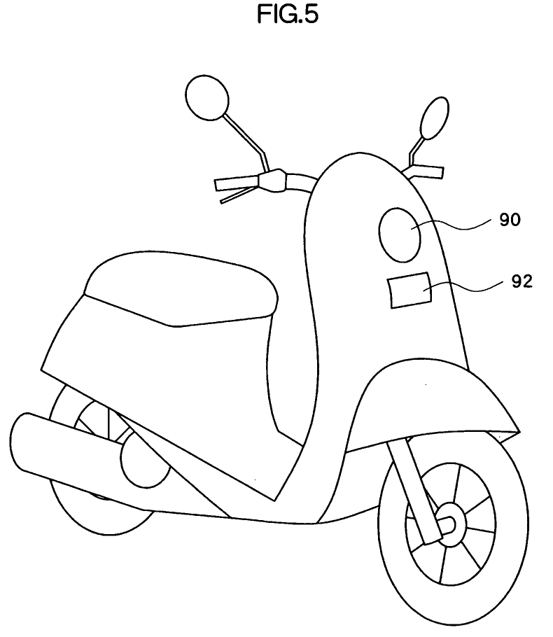

The display meter is a display apparatus that displays data obtained exclusively on the vehicle side, but a configuration is also possible in which the display of another display apparatus is controlled using the electronic key 2. FIG. 5 is a schematic view of a motorcycle showing such an example. The motorcycle is provided with a display apparatus 92 composed of a liquid crystal display or an LED display that is disposed in the front portion of the vehicle, e.g., below a light 90. For example, when the display data of the display apparatus 92 is stored in the storage unit 72 of the electronic key 2 and the electronic key 2 has been inserted in the keyhole 22 and verification established, the display data is displayed in the display apparatus 92 from the storage unit 72 via communication between the electronic key-side circuit 40 and the vehicle-side circuit 42. In this case, a plurality of types of display data can be stored in the storage unit 72 in advance, and the display data can be displayed by using a selection button or an input key in the same manner as the when the display format of the display meter described above is specified so that the display data can be displayed on the display apparatus 92. It is also possible to write the display data from an external apparatus to the storage unit 72 in the manner described above and display the data on the display apparatus 92. For example, the display color of the display apparatus 92 can be set to a desired color, and a famous character or a photographic image of one's children can be displayed on the display apparatus 92.

1. An electronic key system that includes an electronic key for holding identification information and a verification unit for wirelessly connecting to the mounted electronic key and verifying the electronic key, the electronic key system wherein the verification unit has:
a mounting unit that allows the electronic key to be mounted and dismounted,
a communication circuit that is disposed adjacent to the mounting unit, generates a temporally varying transmission electromagnetic field, and detects electromagnetic field variations originating in the electronic key, and
a controller for acquiring the identification information on the basis of the detected electromagnetic field variations, performing verification on the basis of the identification information, and controlling prescribed operation control in accordance with a result of the verification; and the electronic key has:
an antenna for converting variations in the transmission electromagnetic field to drive power of the electronic key and generating the electromagnetic field variations,
a storage unit for holding the identification information, and
a response circuit for varying in a plurality of stages electric current that flows to the antenna in accordance with data that expresses the identification information, and generating the electromagnetic field variations.

2. The electronic key system of claim 1, the electronic key system wherein the response circuit varies the electric current that flows to the antenna in accordance with n-value data (wherein n is an integer of 3 or higher) that expresses the identification information.

3. The electronic key system of claim 2, the electronic key system wherein the response circuit switches impedance of the antenna in n stages.

4. The electronic key system of claim 3, the electronic key system wherein:
the n-value data is expressed in m bits (wherein m is a natural number that meets the expression 2^{m-1}<n≦2^{m}) of binary data;
the response circuit has a selection circuit for outputting in parallel m number of selection signals corresponding to bit values of the n-value data, and m number of resistor circuits provided in accordance with the selection signals and mutually connected in parallel to the antenna; and
the resistor circuits have mutually differing resistance values, and also have switch elements for interrupting the resistor circuits in accordance with the corresponding selection signal.

5. The electronic key system of claim 2, the electronic key system characterized in having a data conversion circuit for converting the identification information stored in the storage unit into the n-value data.

6. The electronic key system of claim 2, the electronic key system wherein the storage unit holds the identification information expressed as the n-value data.

7. The electronic key system of claim 1, the electronic key system wherein:
the electronic key has a stick-shaped insertion portion that houses the antenna;
the mounting portion forms a keyhole slot in which the insertion portion can be inserted; and
the communication circuit has a communication circuit-side antenna that is disposed along a side surface of the keyhole slot, and which electromagnetically couples with the antenna of the electronic key.

8. The electronic key system of claim 7, the electronic key system wherein:
the insertion portion has a recess formed in the surface facing the side surface of the keyhole slot; and
the mounting portion has a latch that receives an urging force, retractably protrudes from the side surface of the keyhole slot, engages the recess of the inserted insertion portion, and interlocks with the electronic key.

9. The electronic key system of claim 8, the electronic key system wherein:
the keyhole slot is configured to be capable of rotating about the insertion direction of the insertion portion; and
the latch releases the interlocking of the electronic key in accordance with rotation of the keyhole slot.

10. The electronic key system of claim 1, comprising a main switch of a motorcycle, the electronic key system wherein:
the verification unit has a verification operation switch that operates in coordination with an engine start switch and sets the communication circuit and the controller in an “on” state; and
the controller determines whether to allow an engine to start as the operation control.

11. The electronic key system of claim 8, comprising a main switch of a motorcycle, the electronic key system wherein:
the mounting portion has a verification operation switch that sets the communication circuit and the controller in an “on” state in accordance with displacement of the latch in a state in which the insertion portion is inserted into the keyhole slot; and
the controller determines whether to allow an engine to start when an engine start switch is operated as the operation control.

12. A motorcycle comprising a main switch constituted using the electronic key system of claim 1, the motorcycle wherein:
a meter unit is provided that is constituted using a display apparatus and that displays a meter in any of a plurality of display formats provided in advance;
the electronic key has a selection button;
the storage unit stores in advance a plurality of specified information that specifies the display format;
the response unit generates the electromagnetic field variations in accordance with the specified information selected when an user operates the selection button; and
the controller acquires the specified information on the basis of the electromagnetic field variations detected by the communication circuit, and sets the display format of the meter unit on the basis of the specified information as the operation control.

13. A motorcycle comprising a main switch constituted using the electronic key system of claim 1, the motorcycle wherein:
a meter unit is provided that is constituted using a display apparatus and that displays a meter in any of a plurality of display formats provided in advance;
the electronic key has an input key;
the storage unit holds specified information that an user inputs by operating the input key;
the response unit generates the electromagnetic field variations in accordance with the specified information; and
the controller acquires the specified information on the basis of the electromagnetic field variations detected by the communication circuit, and sets the display format of the meter unit on the basis of the specified information as the operation control.

14. A motorcycle comprising a main switch constituted using the electronic key system of claim 1, the motorcycle wherein:
a meter unit is provided that is constituted using a display apparatus and that displays a meter in any of a plurality of display formats provided in advance;
the electronic key has a receiver that detects input data from a transmission electromagnetic field from an external apparatus;
the storage unit holds specified information provided as the input data;
the response unit generates the electromagnetic field variations in accordance with the specified information; and
the controller acquires the specified information on the basis of the electromagnetic field variations detected by the communication circuit, and sets the display format of the meter unit on the basis of the specified information as the operation control.

15. A motorcycle comprising a main switch constituted using the electronic key system of claim 1, the motorcycle wherein:
a display unit is provided;
the electronic key has a selection button;
the storage unit stores in advance a plurality of display data of the display unit;
the response unit generates the electromagnetic field variations in accordance with the display data selected when an user operates the selection button; and
the controller acquires the display data on the basis of the electromagnetic field variations detected by the communication circuit, and sets a display content of the display unit to correspond to the display data as the operation control.

16. A motorcycle comprising a main switch constituted using the electronic key system of claim 1, the motorcycle wherein:
a display unit is provided;
the electronic key has a receiver that detects input data from a transmission electromagnetic field from an external apparatus;
the storage unit holds display data of the display unit provided as the input data;
the response unit generates the electromagnetic field variations in accordance with the display data; and
the controller acquires the display data on the basis of the electromagnetic field variations detected by the communication circuit, and sets a display content of the display unit to correspond to the display data as the operation control.
